(19) United States
(12) Patent Application Publication
(10) Pub. No.: US 2005/0201644 A1
(43) Pub. Date: Sep. 15, 2005

(54) Long-lasting self-lubricating large oil barrel

(76) Inventors: Mao-Tu Lee, Taipei County (TW); Hsun-Chen Lee, Taipei County (TW); Chung-Yuan Shun, Taipei County (TW)

Correspondence Address: Abba Linear Tech Co., Ltd., P.O. Box No. 6-57, Junghe,Taipei, 235, TW

(21) Appl. No.: 10/896,841

(22) Filed: Jul. 23, 2004

(30) Foreign Application Priority Data
Mar. 10, 2004 (JP) 2004-67624

(51) Int. Cl. F16C 33/10

(52) U.S. Cl. 384/13

(57) ABSTRACT

A long-lasting self-lubricating large oil barrel includes a sliding a sliding track, a sliding housing and an oil storage tank. The oil storage tank has oil piths, and weight members a lubricating oil at an interior thereof. Using capillarity of the oil piths, the lubricating oil is evenly absorbed and distributed within an oil-containing sponge. With displacement of the oil-containing sponge at the sliding track, the lubricating oil is proportionally applied to the sliding track, thereby accomplishing long-lasting and smooth lubricating effects when a roller is rolled at the sliding track. Using weight of the weight members, the ends of the oil piths are maintained at lowest positions of in the oil storage tank, thereby enabling the oil storage tank to supply the lubricating oil according to different installation directions of the sliding housing and the sliding track to achieve thorough lubricating effects.

### BACKGROUND OF THE INVENTION

(a) Field of the Invention

The invention relates to a long-lasting self-lubricating large oil barrel, and more particularly, to a long-lasting self-lubricating large oil barrel that comprises an oil storage tank having oil piths therein in contact with an oil-containing sponge of a sliding housing thereof. Using capillarity of the oil piths, a lubricating oil in the oil storage tank is evenly absorbed and distributed within the oil-containing sponge. With displacement of the oil-containing sponge at the sliding track, the lubricating oil is proportionally applied to the sliding track, thereby accomplishing long-lasting and smooth lubricating effects when a roller is rolled at the sliding track.

(b) Description of the Prior Art

Mechanics are the parentage of industry. As mechanical industries advance, parts such as line sliding tracks and roller screws are extensively utilized by various processing and transmission apparatuses.

When putting current line sliding tracks and roller screws to application, in order to allow the line sliding tracks and roller screws with smooth displacement and operations, a lubricant is often necessarily added manually.

However, the lubricant added is only capable of maintaining temporary lubricating effects, meaning that it is essential that the lubricant be constantly added to make the lubricating effects last. This is a common shortcoming that causes industrialists and users inconveniences.

In addition, the periodical manual oil supply frequently leads to insufficient lubricating effects of the line sliding tracks and roller screws. As a result, mechanical parts are prone to wear to cause obstructed operations yet adding another shortcoming.

Above all, when a user supplies a lubricating oil, the lubricating oil is likely to ooze out of an oil opening for that the oil opening is too small. A machine base may thus become contaminated by the oil, and product quality may even be further undesirably affected.

### SUMMARY OF THE INVENTION

In view of the aforesaid shortcomings, the primary object of the invention is to provide a long-lasting self-lubricating large oil barrel.

To better understand the contents and accomplished effects of the invention, a preferred embodiment shall be given with the accompanying drawings below.

Referring to FIGS. 1 and 2, the invention comprises a sliding track 1, a sliding housing 2 and an oil storage tank 4.

The oil storage tank 4 is consisted of locating columns 24, 25, 26, 27 and 28, oil piths 33 and 34, and weight members 31 and 32.

The sliding track 2 is disposed with an adjacent connecting housing 3, which has a plurality of locating holes 7, 8, 9, 10 and 11 for accommodating the locating columns 24, 25, 26, 27 and 28 projecting at one side of the oil storage tank 4 as shown in FIG. 2, thereby readily installing and replacing the oil storage tank 4 during application as shown in FIGS. 3 and 4. The locating holes 7, 8, 9, 10 and 11 are respectively provided with grooves 12, 13, 14, 15 and 16 at inner peripheries thereof. The locating columns 24, 25, 26, 27 and 28 are provided with ribs 17, 18, 19, 20 and 21 at outer peripheries thereof. Thus, the oil storage tank 4 is firmly positioned by fastening the grooves 12, 13, 14, 15 and 16 with the ribs 17, 18, 19, 20 and 21. The oil storage tank 4 further has a storage chamber at an interior thereof for accommodating the oil piths 33 and 34, the weight members 31 and 32, and a lubricating oil. The locating columns 27 and 25 are respectively disposed with through openings 5 and 6 for inserting oil supply ends 22 and 23 of the oil piths 33 and 34. When the oil supply ends 22 and 23 come into contact with an oil-containing sponge 35, using capillarity of the oil piths 33 and 34, the lubricating oil in the oil storage tank 4 is evenly absorbed and distributed within the oil-containing sponge. The oil-containing sponge 35 is displaced at the sliding track 1, and thus the lubricating oil is proportionally applied to the sliding track 1, thereby accomplishing long-lasting and smooth lubricating effects when a roller 45 is rolled at the sliding track 1.

Ends 29 and 30 of the oil piths 33 and 34 are respectively inserted with the weight members 31 and 32. Using weight of the weight members 31 and 32, the ends 29 and 30 of the oil piths 33 and 34 are maintained at lowest positions in the oil storage tank 4 as shown in FIGS. 5, 6 and 7, thereby enabling the oil storage tank 4 to supply the lubricating oil according to different installation directions of the sliding housing 2 and the sliding track 1 to achieve thorough lubricating effects.

### BRIEF DESCRIPTION OF THE DRAWINGS

FIG. 1 shows an elevational schematic view of the oil storage tank according to the invention.

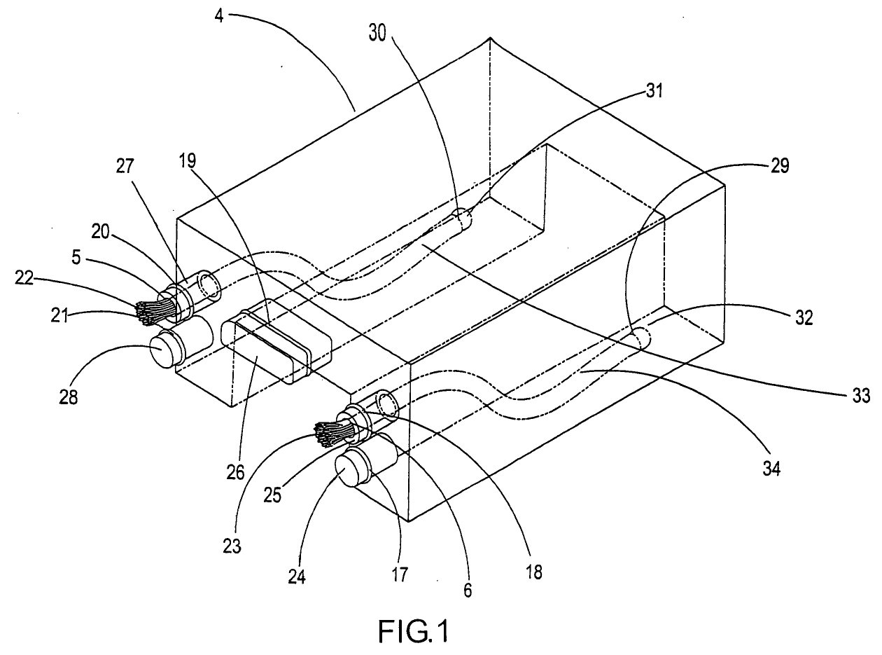

FIG. 2 shows an exploded elevational schematic view illustrating the oil storage tank installed to the linear sliding track according to the invention.

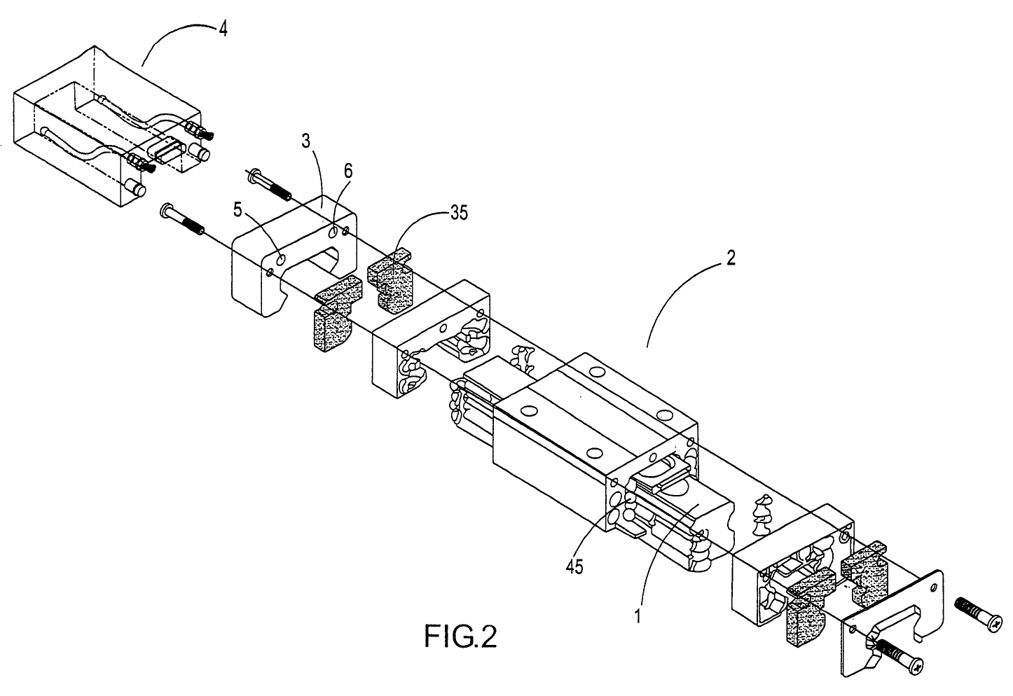

FIG. 2-1 shows an elevational schematic view of the connecting housing of the oil storage tank according to the invention.

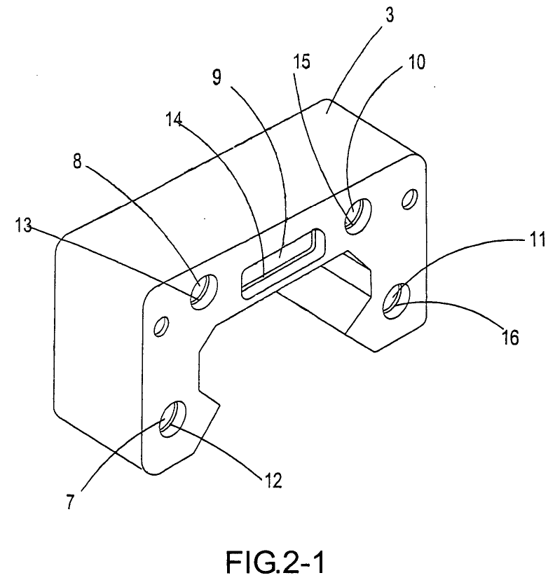

FIG. 3 shows an assembly schematic view illustrating the oil storage tank installed to the linear sliding track according to the invention.

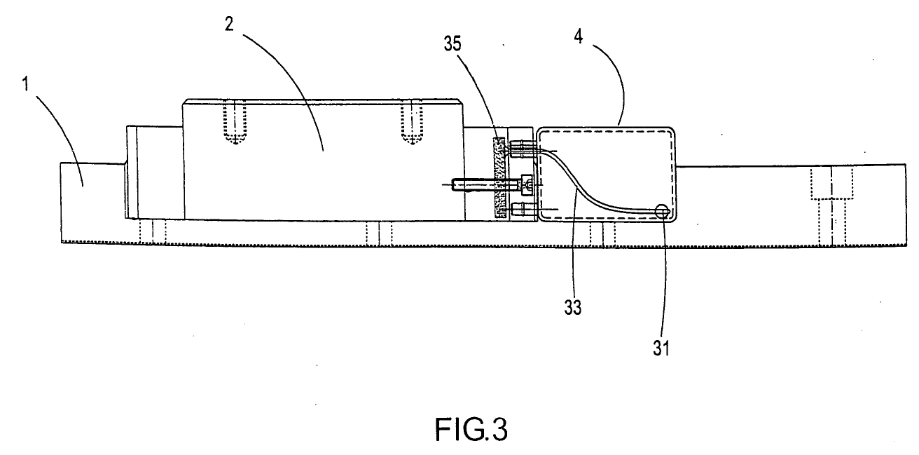

FIG. 4 shows an enlarged partial assembly schematic view illustrating the oil storage tank installed to the linear sliding track according to the invention.

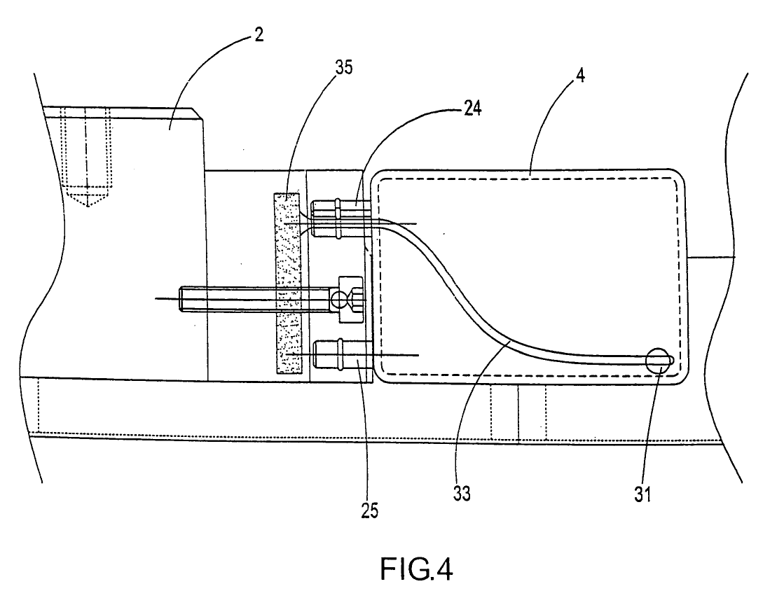

FIG. 5 shows a first assembly schematic view illustrating the oil storage tank installed to the linear sliding track in a different directions according to the invention.

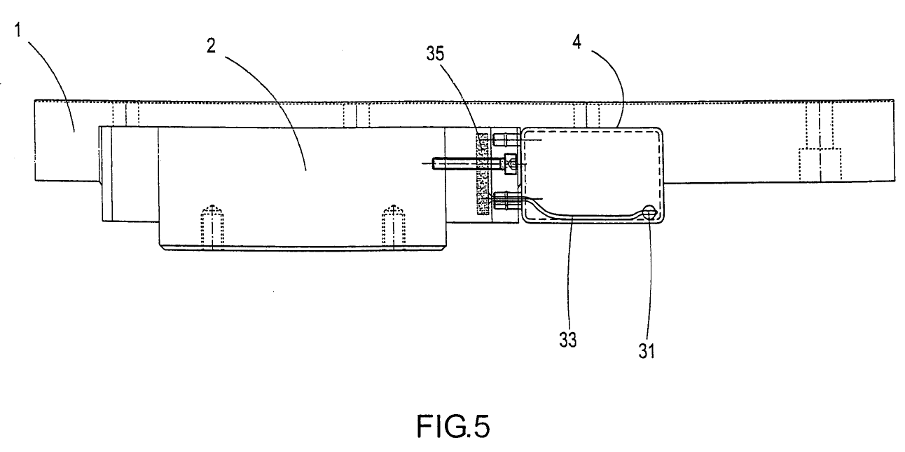

FIG. 6 shows a second assembly schematic view illustrating the oil storage tank installed to the linear sliding track in a different directions according to the invention.

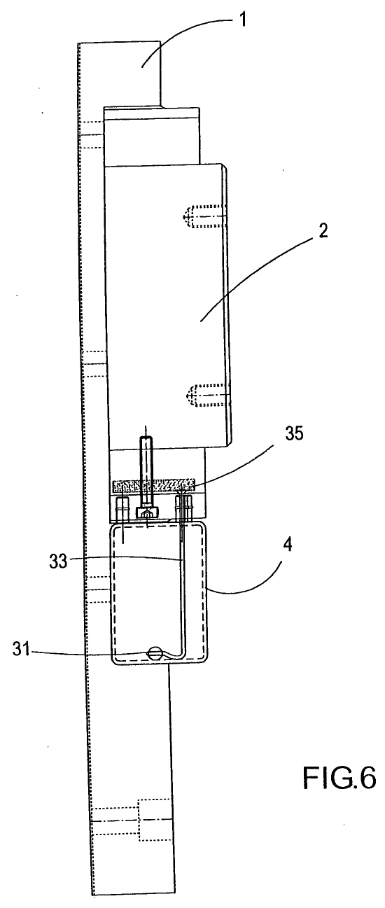

FIG. 7 shows a third assembly schematic view illustrating the oil storage tank installed to the linear sliding track in a different directions according to the invention.

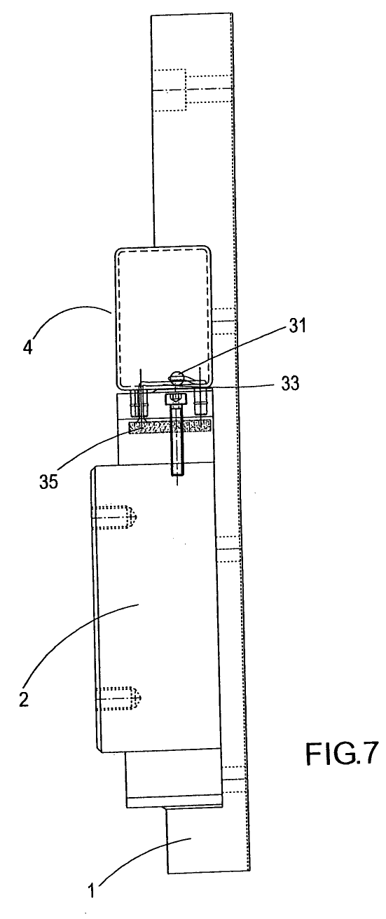

FIG. 8 shows a schematic view showing another assembly of the oil storage tank according to the invention.

FIG. 9 shows an exploded elevational schematic view of another embodiment according to the invention.

FIG. 10 shows an elevational assembly schematic view of the oil storage tank shown in FIG. 9.

### DETAILED DESCRIPTION OF THE PREFERRED EMBODIMENTS

To put the long-lasting self-lubricating large oil barrel according to the invention to use, the oil storage tank 4 is fastened at the sliding track 2, and the oil piths 33 and 34 then come into contact with an oil-containing sponge 35. Using capillarity of the oil piths 33 and 34, the lubricating oil in the oil storage tank 4 is absorbed and distributed within the oil-containing sponge 35. The oil-containing sponge 35 is displaced at the sliding track 1, and thus the lubricating oil is proportionally applied to the sliding track 1, thereby accomplishing long-lasting and smooth lubricating effects when a roller 45 is rolled at the sliding track 1 and lengthening usage lifespan of the sliding housing 2 and the sliding track 1.

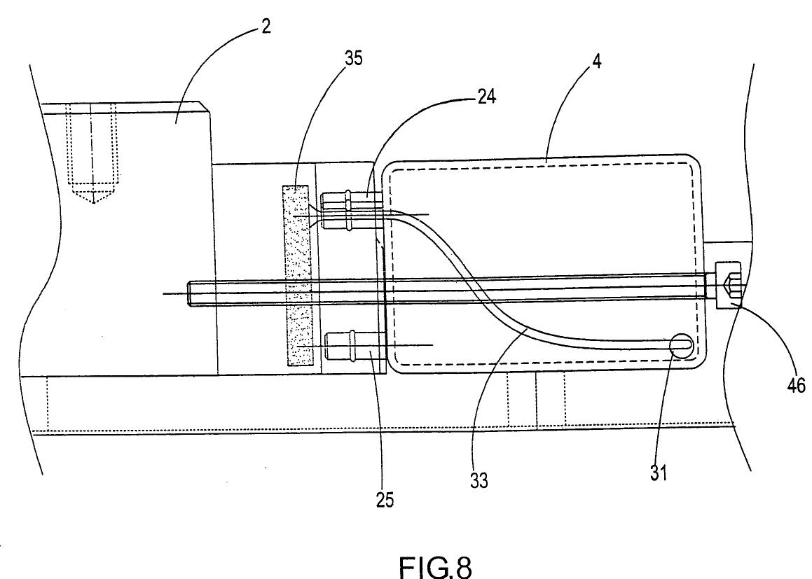

Furthermore, with reference to FIG. 8, according to the invention, a screw bolt 46 may be utilized penetrate through the oil storage tank 4 to be adjusted and fixed at the sliding housing 2. Similarly, quick installation and positioning effects are accomplished. Also, a length of the oil storage tank 4 may be adjusted to adapt to requirements of various customers to further optimize practicability of the invention.

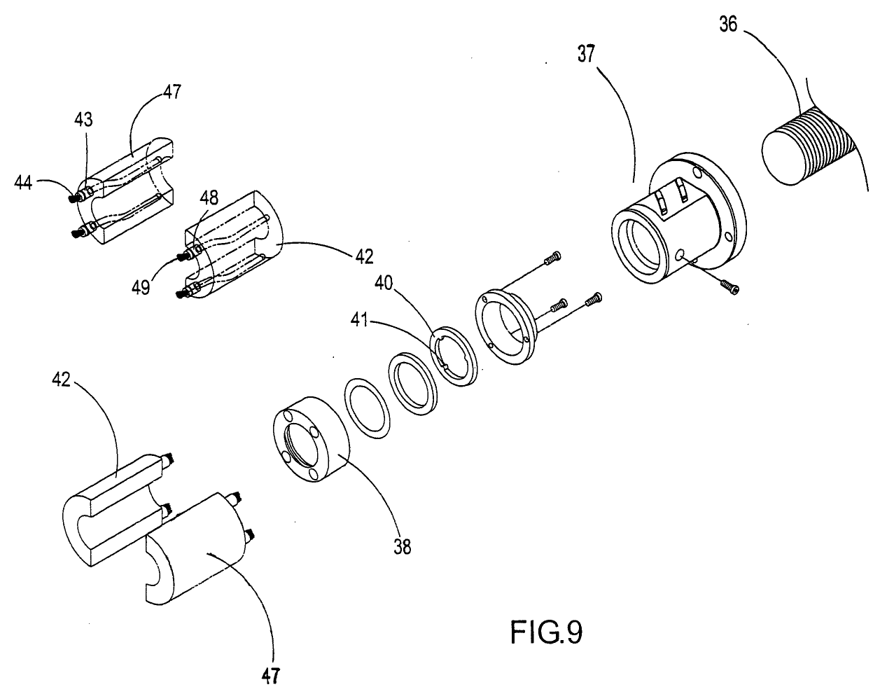

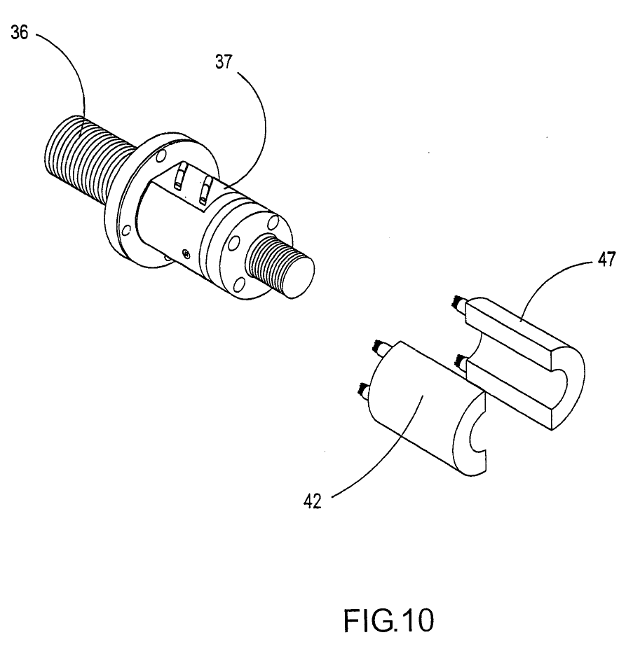

The oil storage tank 4 may be devised as semi-circular oil storage tanks 42 and 47 as shown in FIGS. 9 and 10. Locating columns 43 and 48 of the oil storage tanks 42 and 47 are inset into a fixed lubricating barrel 38 at one side of a roller screw bolt 37. Using oil piths 44 and 49, lubricating oils in the oil storage tanks 42 and 47 are absorbed to a lubricating roller 40 in the fixed lubricating barrel 38. By displacing a tongue-piece 41 of the lubricating roller 40 at screw threads of the roller screw bolt 36, the lubricating oils are similarly applied to the roller screw bolt 36 to achieve long-lasting lubricating effects.

To distinguish the novelty and practicability of the invention, the invention has the excellences below:
1. large oil storage capacity allowing long usage period for offering novelty;
2. thorough lubricating effects with practicability;
3. free from resulting wear of parts or obstructed operations of apparatuses;
4. free from oozing of lubricants;
5. quick installation and assembly processes for offering time efficiency;
6. a length of the oil storage tank being adjustable for adapting to customer requirements for offering flexibility;
7. enhanced product quality;
8. low production cost with simple structures;
9. reduced number of parts;
10. detachment and replacement abilities during application;
11. no restrictions regarding installation directions and thus capable of supplying oils in various directions; and
12. optimized industrial values.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A long-lasting self-lubricating large oil barrel comprising a sliding a sliding track, a sliding housing and an oil storage tank; wherein:
the oil storage tank is consisted of locating columns, oil piths, and weight members;
the sliding track is disposed with an adjacent connecting housing, which has a plurality of locating holes for accommodating the locating columns projecting at one side of the oil storage tank, thereby readily installing and replacing the oil storage tank when in use; the locating holes are respectively provided with grooves at inner peripheries thereof, and the locating columns are provided with ribs at outer peripheries thereof, such that the oil storage tank is firmly positioned by fastening the grooves with the ribs; the oil storage tank further has a storage chamber at an interior thereof for accommodating the oil piths, the weight members, and a lubricating oil therein; the locating columns are respectively disposed with through openings for inserting oil supply ends of the oil piths; when the oil supply ends come into contact with an oil-containing sponge, using capillarity of the oil piths, the lubricating oil in the oil storage tank is evenly absorbed and distributed within the oil-containing sponge; and the oil-containing sponge is displaced at the sliding track, and thus the lubricating oil is proportionally applied to the sliding track, thereby accomplishing long-lasting and smooth lubricating effects when a roller is rolled at the sliding track; and
ends of the oil piths are respectively inserted with the weight members; using weight of the weight members, the ends of the oil piths are maintained at lowest positions of in the oil storage tank, thereby enabling the oil storage tank to supply the lubricating oil according to different installation directions of the sliding housing and the sliding track.

2. The long-lasting self-lubricating large oil barrel in accordance with claim 1, wherein a screw bolt is utilized penetrate through the oil storage tank to be adjusted and fixed at the sliding housing, thereby readily assembling and locating the oil storage tank.

3. The long-lasting self-lubricating large oil barrel in accordance with claim 1, wherein semi-circular oil storage tanks; locating columns of the oil storage tanks are inset into a fixed lubricating barrel at one side of a roller screw bolt; lubricating oils in the oil storage tanks are absorbed to a lubricating roller in the fixed lubricating barrel using oil piths; and by displacing a tongue-piece of the lubricating roller at screw threads of the roller screw bolt, the lubricating oils are similarly applied to the roller screw bolt to achieve long-lasting lubricating effects.
